(19) United States
(12) Patent Application Publication
(10) Pub. No.: US 2008/0216346 A1
(43) Pub. Date: Sep. 11, 2008

(54) Method of Drying Pasty Materials and/or Apparatus for Drying Pasty Materials

(75) Inventors: Tissa Fernando, Auckland (NZ); Michael Robert Kurvink, Auckland (NZ)

Correspondence Address: YOUNG & THOMPSON, 209 Madison Street, Suite 500, ALEXANDRIA, VA, 22314, US

(73) Assignee: Flo-Dry Engineering Limited, Auckland (NZ)

(21) Appl. No.: 11/996,679

(22) PCT Filed: Jul. 24, 2006
(86) PCT No.: PCT/NZ06/00187

§ 371 Date: Jan. 24, 2008

(30) Foreign Application Priority Data
Jul. 25, 2005 (NZ) 541426

(51) Int. Cl. F26B 7/00

(52) U.S. Cl. 34/418

(57) ABSTRACT

The invention comprises method of and apparatus for drying pasty materials. The pasty materials are subjected to a first drying stage (1) at a first temperature, and then subjecting the partially dried pasty material are subjected to a second drying stage (10) at a second temperature. The second temperature is lower than the first temperature. The invention also envisages a method of drying and sterilising a pasty material comprising the steps of subjecting the pasty material to a first heat sterilisation process (1) and then a second heat drying process (10). The invention also envisages a method of drying pasty materials wherein the pasty material is broken into pieces (55) and partially dried (56) to form a crust at least partially over each piece prior to further processing of the pasty

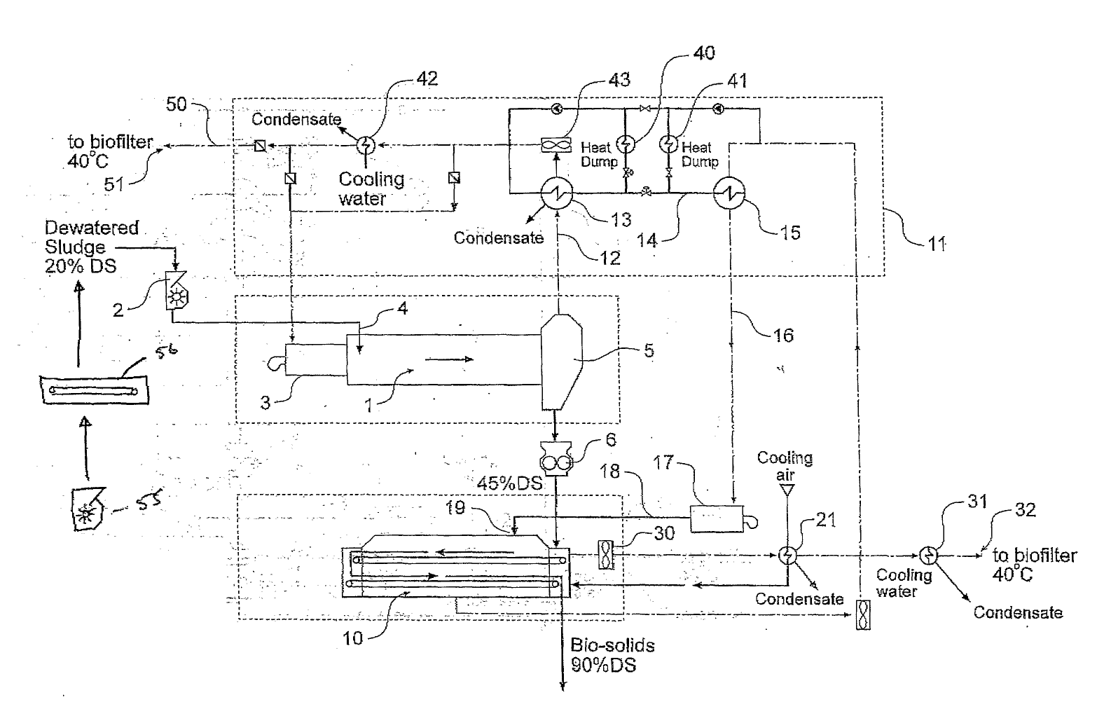

### TECHNICAL FIELD OF THE INVENTION

This invention relates to a method of drying pasty materials and/or apparatus for drying pasty materials such as sludges. Such sludges may comprise semi-solids, sludges and slurries consisting of treated or untreated sewage, or other biological waste material, or indeed other material containing evaporable liquids. Such liquids are usually water but are not exclusively so.

### BACKGROUND ART

Sludges such as sewage sludges, for example, from municipal corporations, sludges from industrial plants such as pulp and paper plants, food processing plants, rendering plants, and waste treatment processes such as dissolved air flotation systems, anaerobic digestion, extended aeration and chemical beneficiation processes may contain a solids content from about 1% to 5%. Typically such sludges are subject to a dewatering process, for example, by mechanical filtering, centrifuging or pressing, to produce sludges that are largely free of free moisture. However the resulting sludge, which is left with essentially bound water, still has a substantial water content. In such sludges the dry solids content may be about 12% to 30%. In order to produce a stable product that is free of pathogens and which can be transported it is desirable to reduce the moisture content of such sludges to below 10%.

### OBJECT OF THE INVENTION

It is therefore an object of the present invention to provide a method of drying pasty materials and/or apparatus for drying pasty materials which will go at least someway towards meeting the foregoing requirements in a simple yet effective manner or which will at least provide the public with a useful choice.

### STATEMENT OF THE INVENTION

Accordingly, in one aspect the invention consists in a method of drying pasty materials comprising the steps of subjecting the pasty materials to a first drying stage at a first temperature, and then subjecting the partially dried pasty material to a second drying stage at a second temperature, the second temperature being lower than the first temperature.

Preferably the first drying stage is effected in a manner to minimise agglomeration of the pasty material.

Preferably the first drying stage is affected in a rotary dryer, the first drying stage being terminated before substantial agglomeration of the sludge occurs.

Preferably the rotary dryer is a drum dryer.

Preferably the second drying stage is affected on a non-agglomerating dryer.

Preferably said second drying stage is affected on a moving bed dryer.

Preferably the second temperature is selected to be below the explosion limits of the material as drying or when dried.

Preferably the first drying stage heats the core temperature of the pasty materials to at least 50° C.

Preferably the first drying stage heats the core temperature of the pasty materials to at least 100° C.

Preferably the first drying stage heats the core temperature of the pasty materials to about 180° C.

Preferably the method further includes the step of comminuting the pasty material between the first drying stage and the second drying stage.

Preferably the method further includes the step of comminuting the pasty material prior to the first drying stage.

Preferably the method includes the further step of dividing the pasty material into pieces and partially drying the pieces prior to said first drying stage.

In a further aspect the invention consists in a method of drying and sterilising a pasty material comprising the steps of subjecting the pasty material to a first heat sterilisation process and then a second heat drying process.

Preferably the sterilisation process is commenced whilst the pasty material is relatively wet.

Preferably the moisture content is greater than 15% by weight.

Preferably the moisture content is in the range 70% to 88% by weight.

In a still further aspect the invention consists in apparatus for drying pasty materials comprising a first dryer operable at a first temperature, and a second dryer operating at a second temperature, the second temperature, being lower than the first temperature.

Preferably said first dryer comprises a single or multi pass dryer.

Preferably said second dryer consists of a single or multi pass dryer.

Preferably said first dryer comprises a rotary dryer.

Preferably said rotary dryer comprises a drum dryer.

Preferably said second dryer comprises a moving bed dryer.

Preferably said second temperature is below the explosion limits of material to be drying or dried on the dryer.

Preferably the first dryer includes a heater able to raise the core temperature of the pasty material to at least 100° C.

Preferably the first dryer includes a heater capable of raising the core temperature of the pasty materials to about 180° C.

Preferably said apparatus further includes a communiter between the first and second dryer.

Preferably said apparatus further includes a further communiter prior to the first dryer.

Preferably said apparatus includes a still further communiter to break the pasty material into pieces prior to the first dryer.

Preferably a pre-dryer is provided to at least partially dry the pasty material prior to the further communiter.

In a still further aspect the invention consists in a method of drying pasty materials wherein the pasty material is broken into pieces and partially dried to form a crust at least partially over each piece prior to further processing of the pasty material.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

One preferred form of the invention will now be described with reference to the accompanying drawing which is a diagrammatic representation of apparatus for drying pasty material according to one preferred form of the invention and illustrating a method of drying pasty material according to one preferred form of the invention.

### BEST MODE FOR CARRYING OUT THE INVENTION

Referring to the drawings pasty material such as dewatered sludge having a dry solids content, for example about 20% DS (dry solids) by weight is input into a first dryer 1. If desired or necessary the dewatered sludge may be passed through a first communiter 2 prior to entering the first dryer. The communiter 2 typically breaks up lumps of material greater than 15 mm to a size range of particles of 10 mm to 20 mm. Essentially the communiter 2 shreds the material to produce uniform discreet particulates for provision to the first dryer 1. Alternatively, comminuter 2 can be an extruder.

The first dryer which may be a single or multi pass dryer, is a dryer capable of being run at a first higher temperature and in the preferred form of the invention is a rotary dryer particularly a drum dryer. The dryer includes a heater 3 which is capable of raising the temperature of the dewatered sludge to a desired core temperature preferably at least 50° C., more preferably 100° C., and even more preferably about 180° C. so that pathogens are quickly substantially eliminated by the heating process.

In the preferred form of rotary dryer 1 a single pass rotary drum drier is provided which is able to operate with air/feed product ratios that are lower than those of conventional rotary drum dyers. The dryer is designed with internal baffles and lifters and the drum is set at an optimum angle of tilt, to ensure the drying in the dryer is carried out in an energy efficient manner and such that heat loss in the exhaust gases are minimised. Such a dryer is available from the applicant and is known as a Flo-Dry Rotary Dryer.

In the first dryer 1 the particulates are dried to 40% to 60% dry solids by weight in the first dryer 1 so that the product does not substantially agglomerate or ball up into lumps. Any lumps formed in the first dryer 1 will be usually no more than 20 mm in diameter. The energy input to first dryer 1 can be by a direct fire burner using such fuels as Natural Gas, LPG, Petroleum Dryer base liquid fuel, bio-gas from digesters, hot exhaust gases from engines producing electricity or from pulverized fuel burners using solid fuel including the final dried sludge output from the present invention.

The inlet temperature of the hot air and combusting gases are desirably in the range of 300° C. to 800° C. which temperatures are substantially higher than temperatures used in prior art dryers. Such temperatures not only reduce the amount of air used in the drying process but also sterilise the sludge meet the requirements of USEPA 503A standards or better.

In the preferred form of the invention the product on entering the feeding in end 4 of the first dryer 1 is heated by the hot gases to rapidly reach a core temperature in the range of 50° C. to 180° C. (being at least 100° C. and preferably about 180° C.) and these temperatures are held for a sufficient time to be equivalent of the conventional sterilisation process which requires holding the final dried product at 80° C. to 90° C. for several minutes and to exceed the current pathogen reduction requirements of the USDA, E.U., and the New Zealand Ministry of the Environment requirements.

The high inlet temperature to the first dryer enables the core temperature of the product to be rapidly reached. The time needed for substantially complete killing of pathogens is in the order of seconds when the core temperature is in the range of 100° C. to 180° C. One reason for the rapid increase in core temperature is that the sterilisation step is carried out at the beginning of the procedure when the moisture content of the sludge is high, for example, around 70% to 88%. This high moisture content has the effect of increasing the heat transfer characteristics of thermal conductivity, specific heat, and the overall heat transfer into the core of the product enabling the product to be heated up to, in the preferred embodiment, 180° C. without damaging the organic heat labile properties of the sludge and also without risk of explosion.

At the feed end 4 of the first dryer 1 the high moisture content substantially prevents dust formation and over heating of the product as the heat applied to the product is substantially utilised in evaporating the water from the sludge.

In prior art constructions heat sterilisation is applied at the end of the process when the moisture content is typically below 15% by weight and may be as low as 10% by weight. In these circumstances heating even to 80° C. at this low moisture content can produce dust with an attendant risk of explosion. The use of the high inlet temperature in first dryer 1 means that the amount of air used in the first dryer 1 is reduced significantly which reduces the absolute oxygen content inside the first dryer 1 again leading to less explosive conditions and furthermore the reduced air reduces the size of the drying and associated equipment such as ducts, fans, and the heat exchange equipment.

Product exiting the outlet end 5 of the first dryer 1 may be fed to a further comminuter 6 which again breaks up any large lumps of particulates to a typical size of 5 mm to 15 mm. One or two slowly rotating shafts (for example 3 to 30 rpm) on which cutters or blades are mounted may be provided in the communiter 6. For some sludges the comminuter 6 may be replaced by an extruder which would product uniform strings of material which could be cut to a selected length of product. Typically the particle size in such a case would be around 2 mm to 8 mm in diameter and 5 mm to 20 mm long.

Accordingly, the product discharge from the comminuter 6 is substantially uniformly sized.

The output product from the communiter 6 is provided to a second dryer 10 which again may be single or multipass. The second dryer 10 operates at a lower temperature than the first dryer and the second dryer 10 is also of a non agglomerating type of which a typical example is a belt dryer. The belt dryer may be heated by hot air, the air being in the range of 30° C. to 150° C. and the second dryer 10 is of sufficient length so that the sludge at the output of the second dryer 10 has a dry solids content desirably of 90% to 95%. The temperature in the second dryer is selected to be sufficiently low to exclude or at least minimise the risk of dust explosion.

In a preferred from of the invention the heat energy for the second dryer 10 is supplied from the heat content in the evaporated water and gases from the dryer 1 which can be condensed and/or cooled in a heat exchanger system 11 to produce hot water at around 35° C. to 95° C. If desired the heat content in the evaporated water and gases from the dryer 1 may be heat exchanged with air to produce the hot air necessary for the second dryer 10. Accordingly, gases at about 100° C. are provided at line 12 where it passes through a heat exchange of 13 to provide water at, for example about 80° C. at 14. The heat exchanger 15 provides gases at say 70° C. at 16 and if necessary a supplementary or makeup air heater 17 is provided to provide gases at around 90° C. at 18 to be input to dryer 10 at 19. The product discharged from second dryer 19 is cooled to around 40° C. to 50° C. in a cooling section within or outside the second dryer 10. Cooling air from the atmosphere at, for example 5° C. to 30° C. may be heat exchanged in an air heat exchanger 21 and used to cool the final dry product.

This use of fans, condensers and heat pumps allows heat energy to be conserved. An ID fan 30 may be provided to enable humid exhaust air from the second dryer 10 which is around 40° C. to 105° C. to be passed through an air/water condenser 31, and the cooled dehumidified air is finally treated in a bio-filter, or any other odour treating device if desired, indicated at 32 so as to reduce any odour in the discharged gases.

Part of the exhaust gas from second dryer 10 is heated in the air/water heat exchanger 15 and reused in the second dryer 10. The exhaust vapour and gases from the dryer 1 are passed through a condenser 13 which is an air/water heat exchanger and the dehumidified air is used as an air input to the first dryer 1. Other heat exchange devices such as heat pumps 40 and 41, and heat exchanger 42, as well as ID fan 43 are used to balance the thermal recovery system indicated generally at 11. The final exhaust from first dryer 1 at 50, is sent to a bio-filter indicated at 51.

For some sludges it can be advantageous to pre-break the wet sludge from the dewatering process into discrete particles of about 25 to 50 mm in a communiter 55.

This can then be pre-heated in heater 56 which could b ea conveying belt dryer utilising recovered heat from the downstream drying process. Other forms of heating such as infra-red, microwave, or electrical. The aim is to heat the outside of the pre-broken particles to form a crust to minimise or prevent balling up of difficult sludges, which could otherwise occur in the communiter 2 or dryer 1. This minimises the creation of dust which may be as low as 1% of the weight of the input wet sludge. This pre-heating forms a crust over at least part, and preferably all, of the surface of each sludge piece.

Thus it can be seen that a method for drying pasty materials and/or apparatus for drying pasty materials is provided which at least in the preferred form of the invention has the advantage that the pasty materials may be dried in an efficient manner to reduce energy consumption, to minimise the risk of agglomeration of the pasty materials during drying so as to minimize maintenance requirements and which also minimises the risk of, in particular, duct explosion. The construction is space and energy efficient whilst maintaining efficiency for maintenance.

As the dried product does not need to be recycled there is a reduction in energy requirements and no recycle pathway, of product being dried, is required, thereby allowing a reduction in the “footprint” of the operations.

Energy requirements can be minimized by using heat exhausted from the first drying stage. It is believed that significant thermal and electrical energy consumption reduction can be achieved when compared to exiting systems.

Providing high heat input at the beginning of the process enables relevant standards to be met.

The process also produces a granular substantially dust free product.

1. A method of drying pasty materials comprising the steps of subjecting the pasty materials to a first drying stage at a first temperature, and then subjecting the partially dried pasty material to a second drying stage at a second temperature, the second temperature being lower than the first temperature.

2. A method as claimed in claim 1 wherein the first drying stage is effected in a manner to minimise agglomeration of the pasty material.

3. A method as claimed in claim 1 wherein the first drying stage is affected in a rotary dryer, the first drying stage being terminated before substantial agglomeration of the sludge occurs.

4. A method as claimed in claim 3 wherein the rotary dryer is a drum dryer.

5. A method as claimed in claim 1 wherein the second drying stage is affected on a non-agglomerating dryer.

6. A method as claimed in claim 5 wherein said second drying stage is affected on a moving bed dryer.

7. A method as claimed in claim 1 wherein the second temperature is selected to be below the explosion limits of the material as drying or when dried.

8. A method as claimed in claim 1 wherein the first drying stage heats the core temperature of the pasty materials to at least 50° C.

9. A method as claimed in claim 8 wherein the first drying stage heats the core temperature of the pasty material to at least 100° C.

10. A method as claimed in claim 9 wherein the first drying stage heats the core temperature of the pasty materials to about 180° C.

11. A method as claimed in claim 1 further including the step of comminuting the pasty material between the first drying stage and the second drying stage.

12. A method as claimed in claim 1 further including the step of comminuting the pasty material prior to the first drying stage.

13. A method as claimed in claim 1 further including the further step of dividing the pasty material into pieces and partially drying the pieces prior to said first drying stage.

14. A method of drying and sterilising a pasty material comprising the steps of subjecting the pasty material to a first heat sterilisation process and then a second heat drying process.

15. A method as claimed in claim 14 wherein the sterilisation process is commenced whilst the pasty material is relatively wet.

16. A method as claimed in claim 15 wherein the moisture content is greater than 15% by weight.

17. A method as claimed in claim 16 wherein the moisture content is in the range 70% to 88% by weight.

18. Apparatus for drying pasty materials comprising a first dryer operable at a first temperature and a second dryer operating at a second temperature the second temperature, being lower than the first temperature.

19. Apparatus as claimed in claim 18 wherein said first dryer comprises a single or multi pass dryer.

20. Apparatus claimed in claim 18 wherein said second dryer consists of a single or multi pass dryer.

21. Apparatus as claimed in claim 18 wherein said first dryer comprises a rotary dryer.

22. Apparatus as claimed in claim 18 wherein said rotary dryer comprises a drum dryer.

23. Apparatus as claimed in claim 18 wherein said second dryer comprises a moving bed dryer.

24. Apparatus as claimed in claim 18 wherein said second temperature is below the explosion limits of material to be drying or dried on the dryer.

25. Apparatus as claimed in claim 18 wherein the first dryer includes a heater able to raise the core temperature of the pasty material to at least 100° C.

26. Apparatus as claimed in claim 18 wherein the first dryer includes a heater capable of raising the core temperature of the pasty materials to about 180° C.

27. Apparatus as claimed in claim 18 wherein said apparatus further includes a communiter between the first and second dryer.

28. Apparatus as claimed in claim 18 wherein said apparatus further includes a further communiter prior to the first dryer.

29. Apparatus as claimed in claim 28 wherein said apparatus includes a still further communiter to break the pasty material into pieces prior to the further communiter:

30. Apparatus as claimed in claim 28 wherein a pre-dryer is provided to at least partially dry the pasty material prior to the further communiter.

31. A method of drying pasty materials wherein the pasty material is broken into pieces and partially dried to form a crust at least partially over each piece prior to further processing of the pasty material.

32-35. (canceled)
